(19) United States
(12) Patent Application Publication
(10) Pub. No.: US 2025/0128888 A1
(43) Pub. Date: Apr. 24, 2025

(54) TRANSPORT DEVICE FOR TRANSPORTING PRODUCTS, AND METHOD FOR TRANSPORTING PRODUCTS BY MEANS OF A TRANSPORT DEVICE

(71) Applicant: SYNTEGON TECHNOLOGY GMBH, Waiblingen (DE)

(72) Inventors: Sebastian Schwarz, Neusitz (DE); Marcus Kleinert, Wallhausen (DE)

(21) Appl. No.: 18/835,548

(22) PCT Filed: Feb. 3, 2023
(86) PCT No.: PCT/EP2023/052648

§ 371 Date: Aug. 2, 2024

(30) Foreign Application Priority Data
Feb. 4, 2022 (DE) 10 2022 102 692.2

(51) Int. Cl. B65G 43/00; B65G 54/02

(52) U.S. Cl. CPC B65G 43/00; B65G 54/02

(57) ABSTRACT

A transport device for a transport of products includes a transport unit having at least one transport element and at least one further transport element on which respectively one product can be arranged for transport. The transport device further includes a drive unit for driving the transport element and the further transport element relative to a drive surface of the drive unit. The transport device further includes at least one control unit for an actuation of the drive unit. The control unit has at least one control routine in which the control unit actuates the drive unit for a movement of the further transport element at least depending on a mass parameter and of a movement parameter of the transport element.

### CROSS-REFERENCE TO RELATED APPLICATIONS

This patent application is a U.S. national stage application of international patent application PCT/EP2023/052648, filed on Feb. 3, 2023, which is based on and claims priority to German patent application DE 10 2022 102 692.2, filed on Feb. 4, 2022, the contents of which are incorporated herein by reference.

### BACKGROUND

The invention concerns a transport device and a method for transporting products.

Such transport devices and methods are already known. With these transport devices and methods it is disadvantageous that undesired forces and oscillations, in particular vibrations, can occur within the transport device due to a drive of one of the transport elements. For example, systems for force cancelation, in which a force cancelation is realized by an acceleration of a constant mass, are known from U.S. Pat. No. 5,251,863 A. However, such systems can be integrated into the above-described transport devices only with difficulty because of their size. A functional range is greatly limited by a fixed number and size of the centrifugal mass and, in addition, a separate control circuit with its own sensor system is required. These disadvantages are overcome by the present invention.

### SUMMARY

The objective of the invention is in particular to provide a generic transport device and a generic method with improved properties regarding low-vibration transport of products and gentle operation of the transport device.

The invention is based on a transport device for a transport of products, with a transport unit comprising at least one transport element and at least one further transport element on which respectively one product can be arranged for transport, with a drive unit for driving the transport element and the further transport element relative to a drive surface of the drive unit, and with at least one control unit for an actuation of the drive unit.

It is proposed that the control unit has at least one control routine in which the control unit actuates the drive unit for a movement of the further transport element at least depending on a mass parameter and of a movement parameter of the transport element. The transport element and/or the further transport element are/is in particular realized as mover/s. Preferably the transport element and/or the further transport element are/is in at least one operation state at least substantially friction-free supported in an electromagnetic field. The drive unit is in particular realized as a planar drive. Preferably, the drive unit is in the operation state configured to generate the electromagnetic field. “Configured” is to mean specially implemented, specially designed and/or specially equipped. By an object being configured for a specific function is to be understood that the object fulfils and/or carries out this specific function in at least one application state and/or operation state. Preferably, at least in the operation state, the drive unit generates electromagnetic forces for a drive of the transport element and the further transport element and/or for an electromagnetic linear support or levitation of the transport element and the further transport element via the, preferably electrically excited, drive surface. Alternatively, it is also conceivable that the drive unit is realized as a fluid-based planar drive.

The drive unit preferably comprises at least one plate element. Preferably the drive unit comprises a plurality of plate elements, wherein the plate elements are preferentially realized identically, or are alternatively realized differently from one another. The plate elements of the plurality of plate elements preferably adjoin one another. In particular, the at least one plate element, respectively the plate elements of the plurality of plate elements, forms/form the drive surface of the drive unit. The at least one plate element has a rectangular or a square shape. Alternatively, it is also conceivable that the at least one plate element has a different shape deemed expedient by a person skilled in the art.

The at least one plate element in particular comprises a coil unit, a sensor unit as well as an electronics unit, in particular a power electronics unit. The plate element is preferably structured in a layer-like manner. In particular, the plate element comprises a coil plane, a sensor plane and/or a power electronics plane. The coil plane in particular comprises the coil unit. The sensor plane in particular comprises the sensor unit. The power electronics plane preferably comprises the electronics unit. Preferably the transport device comprises a connection unit, preferentially a bus system, which connects the at least one plate element, in particular the electronics unit, the coil unit and/or the sensor unit of the plate element, respectively the plurality of plate elements, in particular the respective coil unit, electronics unit and/or sensor unit of the plurality of plate elements, to the control unit, particularly preferably at least in terms of controlling technology.

The transport device in particular comprises an energy supply unit via which the at least one plate element, in particular the electronics unit, the coil unit and/or the sensor unit, can be supplied with electrical energy. For a transmission of electrical energy to the at least one plate element, the energy supply unit for example comprises at least a cable or the like. The control unit in particular comprises at least one processor and a memory element as well as an operating program stored on the memory element. The memory element is preferably realized as a digital storage medium, for example as a hard disk or the like.

The description given in this text section of the transport element and its interaction with further components of the transport device in particular applies analogously to the further transport element. The transport element is movable relative to the drive surface, preferably by means of a drive by the drive unit. Preferably a drive force acting on the transport element can be generated by means of the drive unit, in particular in order to induce a movement, preferentially a translational movement and/or a rotational movement, of the transport element on the drive surface. The transport element is in particular displaceable and/or rotatable in two degrees of freedom relative to the drive surface. Preferably, at least in the operation state, the transport element is movable parallel to the drive surface, preferably in a plane extending parallel to the drive surface. Preferentially, the drive unit is configured to drive the transport element for movements extending at least substantially parallel to the drive surface. Herein “substantially parallel” may mean an orientation of a direction relative to a reference direction, in particular in a plane, wherein the direction differs from the reference direction in particular by less than 8°, advantageously by less than 5° and particularly advantageously by less than 2°. The transport element preferably generates a force onto the drive surface. The transport element preferably comprises at least one magnetic field generating element for generating a magnetic field. The magnetic field generating element is for example realized as a magnet, in particular a permanent magnet, or the like. The magnetic field generating element is in particular configured to interact with the at least one coil unit of the drive unit for driving the transport element. For example, an interaction of the at least one magnetic field generating element of the transport element with the drive unit, in particular with the at least one coil unit, creates an air gap between the drive surface and the transport element.

The transport device comprises at least one detection unit for a detection of the mass parameter at least of the transport element and/or of a mass parameter of the further transport element. The detection unit preferably comprises at least a weighing function, which for example is at least partially integrated in the transport element and/or the further transport element and/or is at least partially realized by the drive unit. The detection unit is in particular configured for a detection of the mass parameter of the transport element and/or of the mass parameter of the further transport element. The mass parameter of the transport element is in particular a total weight of the transport element. The total weight of the transport element is preferably a sum of a weight of the transport element and a weight of products arranged on the transport element. The mass parameter of the further transport element is preferably a total weight of the further transport element. The total weight of the further transport element is preferably a sum of a weight of the further transport element and a weight of products arranged on the further transport element. It is also conceivable that the transport element, respectively the further transport element, is free of products arranged thereon, wherein the mass parameter, in particular the total weight, of the transport element, respectively the further transport element, comprises only the weight of the transport element, respectively the further transport element.

The detection unit is preferably configured for a detection of a position parameter of the transport element and/or of a position parameter of the further transport element. For a detection of the position parameter of the transport element and/or of the further transport element, the detection unit is in particular realized in a manner known to a person skilled in the art. The position parameter of the transport element, respectively the further transport element, in particular comprises at least one piece of information relating to a position of the transport element, respectively the further transport element, on the drive surface. The detection unit is in particular configured to determine a movement parameter, in particular at least an acceleration vector, of the transport element on the basis of detected values for the position parameter of the transport element. It is conceivable that the detection unit is at least partially implemented by the control unit and/or by the sensor unit/s of the drive unit. Alternatively, it is also conceivable that the detection unit is realized separately from the control unit and/or the sensor unit/s.

It is conceivable that the control unit has at least one further control routine in which the control unit actuates the drive unit for a movement of the further transport element independently of the mass parameter and/or of the movement parameter of the transport element. It is conceivable that in the further control routine the control unit actuates the drive unit for a movement of the further transport element depending on a mass parameter of the transport element or depending on a movement parameter of the transport element.

The implementation according to the invention allows providing a transport device which enables particularly device-friendly transport of products. Advantageously, particularly low-oscillation, in particular low-vibration, operation of a transport device can be realized. Advantageously, vibrations within the transport device, which for example could impair a controlling and/or a movement of transport elements, can be at least partially avoided. Advantageously, a particularly reliable and precise transport of products is enabled. Advantageously, damage to products that are to be transported and damage to, in particular sensitive, components of the transport device can be simply and effectively counteracted.

Furthermore, it is proposed that the control unit is configured to drive the further transport element by means of the drive unit with a drive force which depends on a drive force driving the transport element. Preferentially, the drive force driving the transport element, depending on which the drive unit drives the further transport element, is an actual drive force detected and/or determined by the detection unit. Preferably the control unit, in particular the detection unit, is configured to determine an actual drive force acting on the transport element on the basis of a mass parameter of the transport element, which is preferably detected and/or determined by the detection unit, and on the basis of a detected and/or determined movement parameter of the transport element. Alternatively, however, it is also conceivable that the drive force driving the transport element, depending on which the drive unit drives the further transport element, is a target drive force set by the control unit. Advantageously, especially gentle operation of the transport device can be realized by taking into account the drive forces within the transport device. Advantageously, the drive forces of the transport elements of the transport device can be adapted to one another for a particularly low-vibration transport of products.

It is further proposed that the control unit is configured to drive the transport element and the further transport element by means of the drive unit for a movement, wherein a drive force acting on the transport element corresponds, at least in absolute value, at least substantially to a drive force acting on the at least one further transport element. By a value “substantially corresponding” to a further value is in particular to be understood, in this context, that the further value differs from the value by less than 25%, preferably less than 10% and particularly preferably less than 5% of the value. Advantageously, the forces generated by the drive of the transport element and the further transport element can be balanced especially efficiently. Advantageously, especially device-friendly operation of the transport device can be achieved. Advantageously, products can be transported in a particularly low-vibration manner.

Moreover, it is proposed that the control unit is configured to drive the transport element and the further transport element by means of the drive unit for a movement, wherein an acceleration direction of the transport element is at least substantially opposed to an acceleration direction of the at least one further transport element. Herein “substantially opposed” is in particular to mean an orientation of a direction relative to a reference direction, in particular in a plane, wherein a direction that is opposed to the direction differs from the reference direction in particular by less than 8°, advantageously by less than 5° and especially advantageously by less than 2°. Preferentially the control unit is configured to drive the transport element and the further transport element by means of the drive unit for a movement wherein a direction of a drive force acting on the transport element is at least substantially opposed to a direction of a drive force acting on the further transport element. Advantageously, a balancing of forces generated by the drive of the transport element and of the further transport element can be supported and realized within the transport device in a particularly efficient manner. Advantageously, especially gentle, in particular low-vibration, operation of the transport device and transport of products by means of the transport device can be realized.

Beyond this, it is proposed that the transport device comprises a base unit on which the transport unit is arranged, wherein the control unit drives the further transport element, depending on the mass parameter and the movement parameter of the transport element, by means of the drive unit for a movement for the purpose of balancing a force onto the base unit that can be generated by a drive of the transport element. The drive unit, in particular at least the drive surface, is preferably arranged on the base unit. The base unit is in particular realized as a machine frame, as a rack or something like that. In particular, the control unit is configured to drive the transport element and the further transport element by means of the drive unit, wherein drive forces acting on the transport element and the further transport element correspond to each other at least substantially in absolute value, and directions of the drive forces acting on the transport element and the further transport element are at least substantially opposed. In particular, the control unit is configured to drive the transport element and the further transport element, depending on each other, by means of the drive unit in such a way that preferably a force acting onto the base unit is canceled as far as possible. Advantageously, simple and effective balancing of forces generated by a drive of the transport element and acting onto the base unit is enabled. Advantageously, especially gentle operation of the transport device is enabled. It is advantageously achievable that products can be transported in a particularly low-vibration manner. Advantageously, particularly high transport quality is attainable, in particular without additionally required components.

It is furthermore proposed that the transport unit comprises at least one additional transport element or several additional transport elements, wherein the control unit drives all transport elements by means of the drive unit in such a way that forces that can be generated onto the base unit by a drive of the transport elements balance one another. The additional transport element, respectively the several additional transport elements, is/are preferably realized identically to the transport element and/or the further transport element. Alternatively, it is also conceivable that the additional transport element, respectively the several additional transport elements, is/are realized differently from the transport element and/or the further transport element, for example regarding a weight and/or a support surface for products. It is conceivable that with a drive of the transport elements for a balancing of the forces that can be generated onto the base unit, at least one of the transport elements is free of a drive by the drive unit. Preferably the control unit is configured to drive all transport elements by means of the drive unit in such a way that a sum of the drive forces of all transport elements is zero. It is advantageously possible to provide a transport device which enables a balancing of forces that are generated by a drive of the transport elements and act onto the base unit. Advantageously, particularly gentle transport of products and particularly gentle operation of the transport device can be enabled.

Furthermore, it is proposed that for a balancing of a force that can be generated onto the base unit by a drive of at least one of the transport elements, the control unit actuates in a prioritized manner non-loaded transport elements by means of the drive unit for a movement. In particular, a prioritization depends on a mass parameter of the transport elements, preferably a total weight of the transport elements. In particular, the control unit is configured, for a balancing of a force generated onto the base unit by a drive of at least one of the transport elements, to actuate in a prioritized manner transport elements, preferably transport elements that differ from the at least one transport element, by means of the drive unit for a movement, said transport elements having a lower total weight relative to the remaining transport elements. Alternatively or additionally, it is also conceivable that for a balancing of a force that can be generated onto the base unit by a drive of at least one of the transport elements, the control unit actuates in a prioritized manner transport elements by means of the drive unit for a movement, said transport elements being free of a task, preferably a transport task, during a drive of the at least one of the transport elements. Advantageously, it can be at least partially avoided that transport elements carrying out a transport process are actuated for a balancing of drive forces. Advantageously, particularly gentle and at the same time efficient operation of a transport device is achievable.

It is moreover proposed that the control routine can be retrofitted. In particular, it is conceivable that an already known, for example commercially available, transport device, in particular a transport device, can be retrofitted with the control routine. Preferentially the operating program of the control unit can be retrofitted with the control routine. For example, the control routine can be transferred to the control unit in a wire-bound or wireless manner and can preferably be stored on the memory element of the control unit. It is also conceivable that the control routine is stored on a digital data carrier, for example a chip card, a data disk, a hard disk of an SD card or the like, and that the control routine can be retrofitted via a data connection of the digital data carrier to the control unit of the transport device, preferably by attaching the digital data carrier to a data interface of the control unit that corresponds to the digital data carrier. Advantageously, commercially available transport devices can be improved in a particularly simple and cost-effective manner with regard to particularly gentle operation and particularly low-vibration transport of products by means of the transport device.

The invention is furthermore based on a method for transporting products by means of a transport device, in particular a transport device according to the invention, wherein an, in particular the aforementioned, transport element of the transport device, in particular a drive unit, in particular the aforementioned drive unit, of the transport device, is moved relative to an, in particular the aforementioned, drive surface of the drive unit. It is proposed that in a control routine, in particular the aforementioned control routine, at least one, in particular the aforementioned, further transport element of the transport device is moved by the drive unit on the drive surface depending on a mass parameter and on a movement parameter of the transport element. The further transport element is in particular driven by the drive unit with a drive force that depends on a drive force driving the transport element. Preferably the further transport element is driven by the drive unit with a force in such a way that a drive force acting on the transport element corresponds, at least in absolute value, at least substantially to a drive force acting on the at least one further transport element. Preferentially the transport element and the further transport element are driven by an actuation of the drive unit by means of the control unit in such a way that an acceleration direction of the transport element is at least substantially opposed to an acceleration direction of the at least one further transport element. The further transport element is particularly preferably driven, by means of the drive unit, via an actuation of the drive unit by the control unit depending on the mass parameter and the movement parameter of the transport element, for the purpose of, in particular at least substantially, balancing a force onto the base unit that is generated by a drive of the transport element. Advantageously, a transport device can be operated in a particularly gentle manner. It is advantageously possible to realize a particularly low-oscillation, in particular low-vibration, transport of products by means of a transport device.

It is further proposed that the transport device is retrofitted with the control routine. For example, an already known, in particular commercially available, transport device, preferably a transport device, is retrofitted with the control routine. It is conceivable that a transport device that has already been put into operation is retrofitted with the control routine, for example by a transfer of the control routine to the memory unit of the control unit of the transport device. Advantageously, commercially available transport devices can be improved, in a particularly simple and cost-effective manner, with regard to particularly gentle operation and particularly low-vibration transport of products by means of the transport device.

The transport device according to the invention and/or the method according to the invention shall here not be limited to the above-described application and implementation. In particular, for fulfilling a functionality that is described here, the transport device according to the invention and/or the method according to the invention may comprise a number of individual elements, components and units as well as method steps that differs from a number mentioned here. Moreover, with regard to the value ranges indicated in this disclosure, values lying within the mentioned limits shall also be considered to be disclosed and to be usable as desired.

### BRIEF DESCRIPTION OF THE DRAWINGS

Further advantages will become apparent from the following description of the drawing. Two exemplary embodiments of the invention are illustrated in the drawing. The drawing, the description and the claims contain a plurality of features in combination. The person skilled in the art will purposefully also consider the features individually and will find further expedient combinations.

In the drawing:

FIG. 1a shows a transport device according to the invention in a schematic view from a side,

FIG. 1b shows the transport device in a top view,

FIG. 2 shows a method according to the invention for transporting products by means of the transport device, and

FIG. 3 shows a transport device according to the invention in an alternative implementation in a top view.

### DETAILED DESCRIPTION

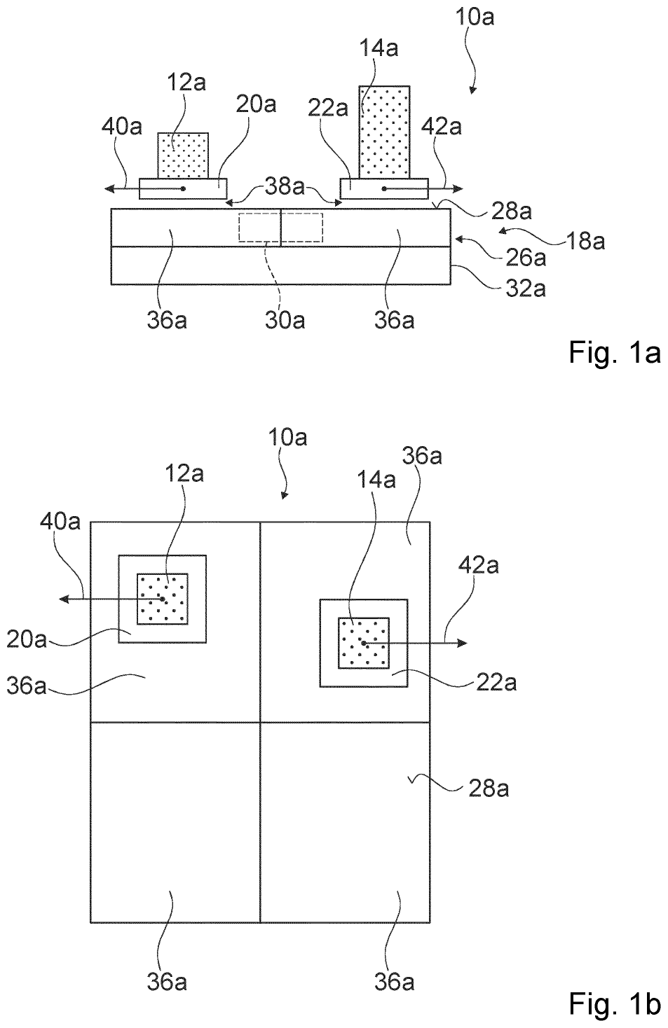

FIGS. 1a and 1b show a transport device 10a for transporting products 12a, 14a. The transport device 10a comprises at least one transport unit 18a. The transport unit 18a comprises at least one transport element 20a and at least one further transport element 22a. The transport element 20a and the further transport element 22a are realized as movers. A product 12a is arranged on the transport element 20a, in particular for a transport. A further product 14a is arranged on the further transport element 22a, in particular for a transport. Alternatively, it is also conceivable that the transport element 20a and/or the further transport element 22a are/is free of products 12a, 14a arranged thereon.

The transport device 10a comprises a drive unit 26a for driving the transport element 20a and the further transport element 22a relative to a drive surface 28a of the drive unit 26a. The transport device 10a comprises at least one base unit 32a. The base unit 32a is realized as a machine frame, as a rack or something like that. The transport unit 18a is arranged on the base unit 32a. For example, via the base unit 32a, the transport unit 18a is connected to a ground (not illustrated here) and is in particular positioned on the ground. Alternatively, it is also conceivable that the base unit 32a is fastened to a wall, a ceiling or the like.

In at least one operation state, the transport element 20a and the further transport element 22a are at least substantially friction-free supported in an electromagnetic field. The drive unit 26a is configured, at least in the operation state, to generate the electromagnetic field. The drive unit 26a generates, at least in the operation state, electromagnetic forces for driving the transport element 20a and the further transport element 22a and/or for an electromagnetic linear support or levitation of the transport element 22a and the further transport element 22a via the, preferably electrically excited, drive surface 28a.

The drive unit 26a comprises four plate elements 36a. Alternatively, it is also conceivable that the drive unit 26a comprises a number of plate elements 36a that differs from four, for example only one plate element 36a, two plate elements 36a, three plate elements 36a, or more than four plate elements 36a. The plate elements 36a are realized identically. Alternatively, it is also conceivable that the plate elements 36a are realized differently from one another. The plate elements 36a are arranged so as to adjoin one another. The plate elements 36a form the drive surface 28a of the drive unit 26a. The plate elements 36a in each case have a rectangular shape. Alternatively, it is also conceivable that the plate elements 36a in each case have a square shape or a different shape deemed expedient by a person skilled in the art.

The plate elements 36a in each case comprise a coil unit (not illustrated here), a sensor unit (not illustrated here) and an electronics unit (not illustrated here), in particular a power electronics unit. The plate elements 36a are in each case structured in a layer-like manner. The plate elements 36a in each case comprise a coil plane (not illustrated here), a sensor plane (not illustrated here) and a power electronics plane (not illustrated here). The respective coil plane of the plate elements 36a is formed by the respective coil unit. The respective sensor plane of the plate elements 36a is formed by the respective sensor unit. The respective power electronics plane of the plate elements 36a is formed by the respective electronics unit, in particular power electronics unit. Alternatively, it is also conceivable that the plate elements 36a in each case have a structure that differs from a layer-like structure and is deemed expedient by a person skilled in the art.

The transport device 10a comprises at least one control unit 30a for an actuation of the drive unit 26a. The control unit 30a comprises at least one processor (not illustrated here) and a memory element (not illustrated here) as well as an operating program stored on the memory element. The memory element is preferably realized as a digital storage medium, for example as a hard disk or the like. The transport device 10a comprises at least one connection unit (not illustrated here), in particular a bus system, which connects the plate elements 36a to the control unit 30a, in particular at least in terms of controlling technology. The transport device 10a comprises at least one energy supply unit (not illustrated here), via which the plate elements 36a, in particular the respective electronics units, the respective coil units and/or the respective sensor units of the plate elements 36a, can be supplied with electrical energy. For a transmission of electrical energy to the plate elements 36a, the energy supply unit for example comprises at least a cable or the like.

The transport element 20a and the further transport element 22a are movable relative to the drive surface 28a, preferably via a drive by the drive unit 26a. By means of the drive unit 26a, a drive force acting on the transport element 20a can be generated in order to induce a movement, preferably a translational movement and/or a rotational movement, of the transport element 20a on, in particular above, the drive surface 28a. By means of the drive unit 26a a drive force acting on the further transport element 22a can be generated in order to induce a movement, preferably a translational movement and/or a rotational movement, of the further transport element 22a on, in particular above, the drive surface 28a. The transport element 20a and the further transport element 22a are in each case displaceable and/or rotatable relative to the drive surface 28a in two degrees of freedom.

The transport element 20a and the further transport element 22a in each case generate a force onto the drive surface 28a. The transport element 20a and the further transport element 22a in each case comprise at least one magnetic field generating element (not illustrated here) for generating a magnetic field. The magnetic field generating element is for example realized as a magnet, in particular as a permanent magnet. The magnetic field generating element of the transport element 20a is configured to interact with the coil units of the drive unit 26a for driving the transport element 20a. For example, an interaction of the at least one magnetic field generating element of the transport element 20a with the drive unit 26a, in particular the coil units of the drive unit 26a, creates an air gap 38a between the drive surface 28a and the transport element 20a. The magnetic field generating element of the further transport element 22a is configured to interact with the coil units of the drive unit 26a for driving the further transport element 22a. An interaction of the at least one magnetic field generating element of the further transport element 22a with the drive unit 26a, in particular the coil units of the drive unit 26a, creates an air gap 38a between the drive surface 28a and the further transport element 22a.

The control unit 30a comprises at least one control routine in which the control unit 30a actuates the drive unit 26a for a movement of the further transport element 22a at least depending on a mass parameter and of a movement parameter of the transport element 20a.

The transport device 10a comprises at least one detection unit (not illustrated here) for a detection of the mass parameter at least of the transport element 20a and/or of a mass parameter of the further transport element 22a. The detection unit preferably has at least a weighing function which is, for example, at least partially integrated in the transport element 20a and/or the further transport element 22a and/or is at least partially realized by the drive unit 26a. The detection unit is configured for a detection of the mass parameter of the transport element 20a and/or of the mass parameter of the further transport element 22a. The mass parameter of the transport element 20a is in particular a total weight of the transport element 20a. The total weight of the transport element 20a is a sum of a weight of the transport element 20a and a weight of the product 12a that is arranged on the transport element 20a. Alternatively, it is also conceivable that the transport element 20a is free of products 12a, 14a arranged thereon, with the mass parameter, in particular the total weight, of the transport element 20a comprising only the weight of the transport element 20a. The mass parameter of the further transport element 22a is a total weight of the further transport element 22a. The total weight of the further transport element 22a is a sum of a weight of the further transport element 22a and a weight of the product 14a that is arranged on the further transport element 22a. Alternatively, it is also conceivable that the further transport element 22a is free of products 12a, 14a arranged thereon, with the mass parameter, in particular the total weight, of the further transport element 22a comprising only the weight of the further transport element 22a.

The detection unit is configured for a detection of a position parameter of the transport element 20a and/or of a position parameter of the further transport element 22a. The detection unit is in particular built, in a manner known to a person skilled in the art, for a detection of the position parameter of the transport element 20a and/or of the further transport element 22a. The detection unit is configured to determine a movement parameter, in particular at least an acceleration vector, of the transport element 20a on the basis of detected values for the position parameter of the transport element 20a. The detection unit is configured to determine a movement parameter, in particular at least an acceleration vector, of the further transport element 22a on the basis of detected values for the position parameter of the further transport element 22a. It is conceivable that the detection unit is at least partially implemented by the control unit 30a and/or by the sensor units of the drive unit 26a. Alternatively, it is also conceivable that the detection unit is realized separately from the control unit 30a and/or from the sensor units.

It is conceivable that the control unit 30a has at least one further control routine, in which the control unit 30a actuates the drive unit 26a for a movement of the further transport element 22a independently of the mass parameter and/or of the movement parameter of the transport element 20a. It is conceivable that in the further control routine the control unit 30a actuates the drive unit 26a for a movement of the further transport element 22a depending on the mass parameter of the transport element 20a or depending on the movement parameter of the transport element 20a.

The control unit 30a is configured to drive the further transport element 22a by means of the drive unit 26a with a drive force that depends on a drive force driving the transport element 20a. The drive force driving the transport element 20a, depending on which the drive unit 26a drives the further transport element 22a, is an actual drive force detected and/or determined by the detection unit. Alternatively, it is also conceivable that the drive force driving the transport element 20a, depending on which the drive unit 26a drives the further transport element 22a, is a target drive force set by the control unit 30a. The control unit 30a, in particular the detection unit, is configured to determine an actual drive force acting on the transport element 22a on the basis of the mass parameter of the transport element 20a, which is detected and/or determined preferably by the detection unit, and on the basis of the detected and/or determined movement parameter of the transport element 20a.

The control unit 30a is configured to drive the transport element 20a and the further transport element 22a by means of the drive unit 26a for a movement, wherein a drive force acting on the transport element 20a corresponds, at least in absolute value, at least substantially to a drive force acting on the at least one further transport element 22a. The control unit 30a is configured to drive the transport element 20a and the further transport element 22a by means of the drive unit 26a for a movement, wherein an acceleration direction of the transport element 20a is at least substantially opposed to an acceleration direction of the at least one further transport element 22a. The control unit 30a is configured to drive the transport element 20a and the further transport element 22a by means of the drive unit 26a for a movement, wherein a direction of a drive force acting on the transport element 20a is at least substantially opposed to a direction of a drive force acting on the further transport element 22a.

The control unit 30a drives the further transport element 22a by means of the drive unit 26a depending on the mass parameter and on the movement parameter of the transport element 20a for a movement for the purpose of balancing a force onto the base unit 32a that can be generated by a drive of the transport element 20a. The control unit 30a is configured to drive the transport element 20a and the further transport element 22a by means of the drive unit 26a, wherein drive forces acting on the transport element 20a and the further transport element 22a correspond to each other at least substantially in absolute value, and directions of the drive forces acting on the transport element 20a and the further transport element 22a are at least substantially opposed. The control unit 30a is in particular configured to drive the transport element 20a and the further transport element 22a, depending on each other, by means of the drive unit 26a in such a way that a force acting onto the base unit 32a is canceled as far as possible.

In FIGS. 1a and 1b a force vector 40a of a drive force created by a drive of the transport element 20a by means of the drive unit 26a and acting onto the transport element 20a is depicted by way of example. The control unit 30a actuates the drive unit 26a for a drive of the further transport element 22a for a movement in such a way that a force vector 42a of a drive force acting on the further transport element 22a is at least substantially opposed to the force vector 40a, and the lengths of the force vectors 40a and 42a preferably are at least substantially equivalent.

The control routine can be retrofitted. It is conceivable that an already known, in particular commercially available, transport device 10a can be retrofitted with the control routine. Preferentially the operating program of the control unit 30a can be retrofitted with the control routine. For example, the control routine can be transferred to the control unit 30a in a wire-bound or wireless manner and can preferably be stored on the memory element of the control unit 30a. It is also conceivable that the control routine is stored on a digital data carrier, for example a chip card, a data disk, a hard disk of an SD card or the like, and that the control routine can be retrofitted via a data connection of the digital data carrier to the control unit 30a of the transport device 10a, preferably by attaching the digital data carrier to a data interface of the control unit 30a that corresponds to the digital data carrier.

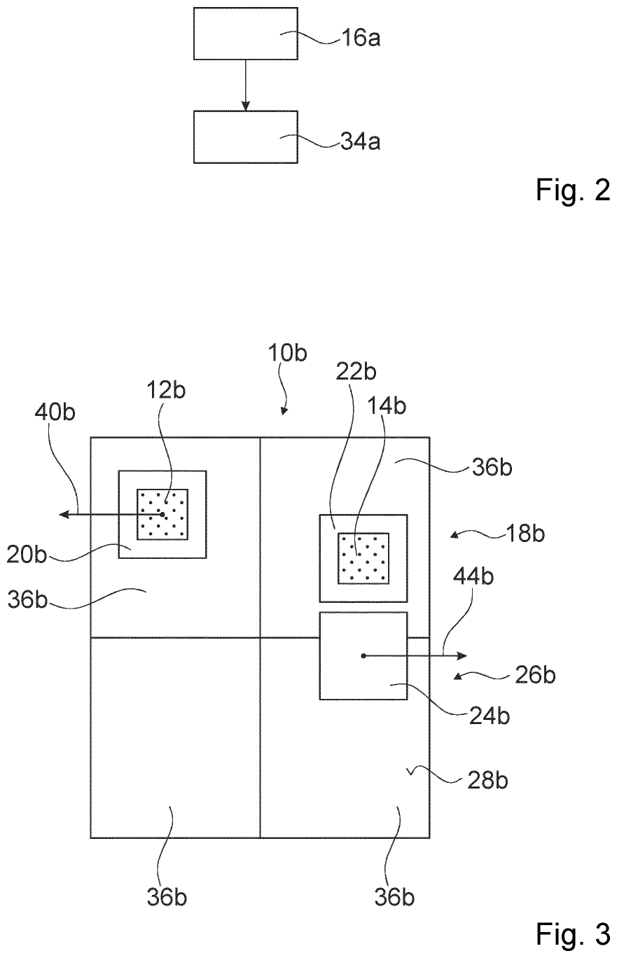

FIG. 2 shows a schematic sequence of a method for transporting products 12a, 14a by means of the transport device 10a. The transport device 10a is, in particular in a method step 16a, retrofitted with the control routine. Alternatively, it is also conceivable that the transport device 10a is already equipped with the control routine during a production of the transport device 10a. For example, the transport device 10a is an already known, in particular commercially available, transport device 10a that is retrofitted with the control routine. It is conceivable that the transport device 10a is a transport device 10a which has already been put into operation and is retrofitted with the control routine, for example by a transfer of the control routine to the memory element of the control unit 30a of the transport device 10a.

The transport element 20a is, in particular in a method step 34a, moved by the drive unit 26a relative to the drive surface 28a. In the control routine, in particular in the method step 34a, the further transport element 22a is moved by the drive unit 26a on the drive surface 28a, depending on the mass parameter and on the movement parameter of the transport element 20a. The further transport element 22a is driven by the drive unit 26a with a drive force that depends on a drive force driving the transport element 20a.

The further transport element 22a is driven by the drive unit 26a with a force in such a way that a drive force acting on the transport element 20a corresponds, at least in absolute value, at least substantially to a drive force acting on the at least one further transport element 22a. The transport element 20a and the further transport element 22a are, in particular in the method step 34a, driven via an actuation of the drive unit 26a by the control unit 30a in such a way that an acceleration direction of the transport element 20a is at least substantially opposed to an acceleration direction of the further transport element 22a. The further transport element 22a is, in particular in the method step 34a, driven by the drive unit 26a via an actuation of the drive unit 26a by the control unit 30a depending on the mass parameter and the movement parameter of the transport element 20a, for the purpose of, in particular at least substantially, balancing a force onto the base unit 32a that is generated by a drive of the transport element 20a.

A further exemplary embodiment of the invention is shown in FIG. 3. The following descriptions and the drawings are essentially limited to the differences between the exemplary embodiments wherein, with regard to components having the same denomination, in particular with regard to components with the same reference numerals, reference can in principle also be made to the drawings and/or the description of the other exemplary embodiment, in particular of FIGS. 1a to 2. To distinguish between the exemplary embodiments, the letter a has been added to the reference numerals of the exemplary embodiment in FIGS. 1a to 2. In the exemplary embodiment of FIG. 3, the letter a has been replaced by the letter b.

FIG. 3 shows a transport device 10b for a transport of products 12b, 14b. The transport device 10b comprises a transport unit 18b. The transport unit 18b comprises at least one transport element 20b and at least one further transport element 22b. A product 12b is arranged on the transport element 20b, in particular for a transport. A further product 14b is arranged on the further transport element 22b, in particular for a transport. The transport unit 18b comprises at least one additional transport element 24b. Alternatively, it is also conceivable that the transport unit 18b comprises several additional transport elements 24b. The additional transport element 24b is free of a product 12b, 14b arranged on the additional transport element 24b. The additional transport element 24b is realized identically to the transport element 20b and/or to the further transport element 22b. Alternatively, it is also conceivable that the additional transport element 24b is realized differently from the transport element 20b and/or from the further transport element 22b, for example regarding a weight and/or regarding a support surface for products 12b, 14b.

The transport device 10b comprises a drive unit 26b for driving the transport element 20b, the further transport element 22b and the additional transport element 24b relative to a drive surface 28b of the drive unit 26b. The drive surface 28b is formed by several plate elements 36b, in particular by a surface of the several plate elements 36b. The transport device 10b comprises at least one control unit (not illustrated here) for an actuation of the drive unit 26b.

The control unit drives all transport elements 20b, 22b, 24b by means of the drive unit 26b in such a way that forces that can be generated onto a base unit (not illustrated here) of the transport device 10b by a drive of the transport elements 20b, 22b, 24b balance one another. It is conceivable that with a drive of the transport elements 20b, 22b, 24b for a balancing of the forces that can be generated onto the base unit, at least one of the transport elements 20b, 22b, 24b is free of a drive by the drive unit 26b. The control unit is configured to drive all transport elements 20b, 22b, 24b by means of the drive unit 26b in such a way that a sum of the drive forces of all transport elements 20b, 22b, 24b is at least substantially zero.

For a balancing of a force that can be generated onto the base unit by a drive of at least one of the transport elements 20b, 22b, the control unit actuates in a prioritized manner non-loaded transport elements 24b by means of the drive unit 26b for a movement. A prioritization depends on a respective mass parameter of the transport elements 20b, 22b, 24b.

For a balancing of a force that is generated onto the base unit by a drive of at least one of the transport elements 20b, 22b, 24b, the control unit is configured to actuate in a prioritized manner transport elements 20b, 22b, 24b, preferably transport elements that differ from the at least one transport element 20b, 22b, 24b, by means of the drive unit 26b for a movement, said transport elements 20b, 22b, 24b having a lower total weight relative to the remaining transport elements 20b, 22b, 24b. For example, for a balancing of a force that is generated onto the base unit by a drive of the transport element 20b, the control unit is configured to actuate in a prioritized manner the additional transport element 24b by means of the drive unit 26b for a movement, since the additional transport element 24b has a lower total weight than the further transport element 22b. FIG. 3 exemplarily shows a force vector 40b of a drive force generated by a drive of the transport element 20b via the drive unit 26b and acting onto the transport element 20b. The control unit actuates the drive unit 26b for a drive of the additional transport element 24b for a movement in such a way that a force vector 44b of a drive force acting on the additional transport element 24b is opposed to the force vector 40b, and the lengths of the force vectors 40b and 44b preferably are at least substantially equivalent.

However, it is alternatively also conceivable, for example, that for a balancing of a force generated onto the base unit by a drive of the transport element 20b, the control unit actuates the additional transport element 24b and the further transport element 22b, or only the further transport element 22b, by means of the drive unit 26b for a movement. For example, alternatively, for a balancing of a force generated onto the base unit by a drive of the transport element 20b, the control unit is configured to actuate the further transport element 22b and the additional transport element 24b for a movement, wherein a total force vector, realized as a sum of the force vector 44b belonging to the drive force acting on the additional transport element 24b and a force vector (not shown here) belonging to the drive force acting on the further transport element 22b, is at least substantially opposed to the force vector 40b and at least substantially corresponds to the length of the force vector 40b.

Alternatively or additionally, it is also conceivable that for a balancing of a force that can be generated onto the base unit by a drive of at least one of the transport elements 20b, 22b, 24b, the control unit actuates in a prioritized manner transport elements 20b, 22b, 24b by means of the drive unit 26b for a movement, said transport elements being free of a task, preferably a transport task, during a drive of the at least one of the transport elements 20b, 22b, 24b.

1. A transport device for a transport of products the transport device comprising: a transport unit comprising at least one transport element and at least one further transport element on which respectively one product can be arranged for transport, with a drive unit for driving the at least one transport element and the at least one further transport element relative to a drive surface of the drive unit, and at least one control unit for an actuation of the drive unit, wherein the control unit has at least one control routine in which the control unit actuates the drive unit for a movement of the at least one further transport element at least depending on a mass parameter and of a movement parameter of the at least one transport element.

2. The transport device according to claim 1, wherein the control unit is configured to drive the at least one further transport element by the drive unit with a drive force that depends on a drive force driving the at least one transport element.

3. The transport device according to claim 1, wherein the control unit is configured to drive the at least one transport element and the at least one further transport element by the drive unit for a movement, wherein a drive force acting on the at least one transport element corresponds, at least in absolute value, at least substantially to a drive force acting on the at least one further transport element.

4. The transport device according to claim 1, wherein the control unit is configured to drive the at least one transport element and the at least one further transport element by the drive unit for a movement, wherein an acceleration direction of the at least one transport element is at least substantially opposed to an acceleration direction of the at least one further transport element.

5. The transport device according to claim 1, by further comprising a base unit on which the transport unit is arranged, wherein the control unit drives the at least one further transport element by the drive unit, depending on a mass parameter and a movement parameter of the at least one transport element, for a movement for the purpose of balancing a force onto the base unit that can be generated by a drive of the at least one transport element.

6. The transport device according to claim 5, wherein the transport unit comprises at least one additional transport element or several additional transport elements, wherein the control unit drives all transport elements by the drive unit in such a way that forces that can be generated onto the base unit by a drive of all the transport elements balance one another.

7. The transport device according to claim 6, wherein for a balancing of a force that can be generated onto the base unit by a drive of at least one of the transport elements, the control unit actuates in a prioritized manner non-loaded transport elements by the drive unit for a movement.

8. The transport device according to claim 1, wherein the control routine can be retrofitted.

9. A method for transporting products by a transport device, wherein a transport element of the transport device is moved by a drive unit of the transport device relative to a drive surface of the drive unit, wherein with a control routine at least one further transport element of the transport device is moved by the drive unit on the drive surface depending on a mass parameter and on a movement parameter of the transport element.

10. The method according to claim 9, wherein the transport device is retrofitted with the control routine.
